(19) United States
(12) Patent Application Publication
(10) Pub. No.: US 2011/0246003 A1
(43) Pub. Date: Oct. 6, 2011

(54) Approach Phase Monitoring System for an Aircraft

(75) Inventors: Stéphanie Lafon, Merignac (FR); Bernard Dubourg, Le Haillan (FR); François Michel, Saint Medard en Jalles (FR)

(73) Assignee: THALES, Neuilly-sur-Seine (FR)

(21) Appl. No.: 12/898,559

(22) Filed: Oct. 5, 2010

(30) Foreign Application Priority Data
Oct. 6, 2009 (FR) 09 04768

(51) Int. Cl. G08G 5/02; G06F 19/00

(52) U.S. Cl. 701/16

(57) ABSTRACT

The invention relates to a monitoring system dedicated to the landing of an aircraft including means of receiving navigation data, means of receiving a plurality of landing area monitoring information, and display means representing, by various symbols, the landing area and the monitoring information, including means of determining a plurality of successive approach phases constituting the landing procedure and of signalling the current approach phase, means of calculating a plurality of cartographic scale factors of the landing area, and means of selecting monitoring information to be displayed for each approach phase. The display means represent the landing area according to a changing cartographic scale factor and the selected monitoring information by symbols that also change, the cartographic scale factor and the symbols changing automatically according to the current approach phase.

### CROSS-REFERENCE TO RELATED APPLICATION

This application claims priority to foreign French patent application No. FR 0904768, filed on Oct. 6, 2009, the disclosure of which is incorporated by reference in its entirety.

### FIELD OF THE INVENTION

The field of the invention relates to aeronautical monitoring systems. This system applies more particularly to the approach phase of an aircraft.

### BACKGROUND OF THE INVENTION

The approach phase is one of the most critical phases of the flight, approximately 51% of accidents occurring in approach and landing. This phase is very short compared to the duration of a flight, and it constitutes the transition between the flight and movement on the ground. However, accidents occur for many reasons: approach speed too high for the runway length, poor assessment of runway conditions, runway touchdown point too distant, runways cluttered with obstacles, etc.

Currently, there are systems that offer the pilots piloting aid equipment. Among these systems, there are an airport signalling simulator as described in the patent document US2002099528A1 that makes it possible to monitor the descent regardless of weather conditions, a device for displaying realistic 3D approach representations as described in the patent document CA976645A and a variety of guidance symbol panels displayed on head-up collimators as described in the patent document FR2884021A1.

However, it is also important to offer the pilots functionalities suited to their operational needs to improve their perception of the situation and to enable them to act best in the shortest possible time. In practice, during the landing, the crew members must constantly monitor the runway and its surroundings in order to decide on any go-around. Furthermore, the workload on the crew is very high and the margin for manoeuvre to make up for an error is low. At the present time, there is no summary view of all the information needed to monitor this area during the approach such as the presence of traffic, the weather conditions (fog, wind, etc.), the cluttering of the runway (presence of traffic, risk of slipstream turbulences, etc.), the condition of the runway (in service or not, wet, slippery, etc.), the situation of the aeroplane relative to the runway or the situation of the runway relative to the airport (exit from taxiways, stopping area, other runways, etc.).

For this, there are navigation aid systems that supply a 2D representation of the terrain that provides an overview of the monitoring information. The navigation aid system as described in the patent document US2007250224A1 partly addresses this need. In practice, the navigation aid system supplies a 2D representation of data useful to the landing such as the 2D representation of the airport area, notably of the landing/take-off runways. Such information is supplied by databases and is totally or partly represented. This system offers various simultaneous displays of this area (horizontal view, vertical view, perspective view), possibly a window dedicated to the aircraft-related data, graphic and textual information relating to the landing runway (characteristics, braking-related data, etc.), information from weather data, the terrain collision avoidance device (TAWS, standing for “terrain awareness and warning system”), the traffic alert and collision avoidance system (TCAS, standing for “traffic collision avoidance system”), the instrument landing system (ILS), navigation information (heading to be followed, distances to be travelled, political boundaries, useful radio frequencies, etc.). Some of these data are updated by the information reception system such as the air traffic control (ATC) instructions and weather bulletins. The pilot can also modify the representation scale (range) or the type of view for viewing certain particular details. However, this system still has drawbacks. In practice, during the approach phase, the workload on the pilot is very great because of the large quantity of information to be assimilated and analysed in order to take the right decisions. The views offered by this monitoring system are useful for pre-landing briefing but are not suitable for use in real time during the approach phase.

### SUMMARY OF THE INVENTION

The invention resolves the abovementioned drawbacks that are not resolved by the existing solutions.

More specifically, the invention is a monitoring system dedicated to the approach phases, including the landing phase, of an aircraft comprising means of receiving navigation data, means of receiving a plurality of landing area monitoring information, and display means representing, by various symbols, the landing area and the monitoring information. The monitoring system also comprises means of determining a plurality of successive approach phases and of signalling the current approach phase, the approach phases being deduced from the navigation data, means of calculating a plurality of cartographic scale factors of the landing area, one factor being dedicated to one approach phase, and means of selecting monitoring information to be displayed for each approach phase, the selected information depending on the current approach phase. The abovementioned means are arranged together so that, during the approach phases, the display means represent the landing area according to a changing cartographic scale factor and the selected monitoring information by symbols that also change, the cartographic scale factor and the symbols changing automatically according to the current approach phase.

Advantageously, the display means modify a first cartographic scale factor to a second factor according to a progressive transition produced during the transition from one approach phase to the next approach phase. The pilot is thus aware of the progress of the landing and of the current approach phase which may possibly be signalled in another way to avoid any confusion.

Advantageously, the means of calculating the cartographic scale factors are configured to define a plurality of factors before the approach phases. The scale factors can thus be configured before the landing procedure.

According to a variant of the system, the means of calculating the cartographic scale factors are configured to define a plurality of factors as the approach phases progress according to the monitoring information, notably location and dimension information concerning elements to be monitored. In this more sophisticated variant, the scale factor can be adapted according to the position of cluttering elements in proximity to the landing runway.

According to a variant of the invention, the system also comprises aircraft configuration and performance data sources, and the means of calculating the cartographic scale factors are configured to define a plurality of factors as the approach phases progress according to said data, notably braking distance data.

Advantageously, the display means represent a monitoring information item by a symbol, the shape and the graphic representation characteristics of which change according to the current approach phase.

Preferably, the landing comprises at least four successive approach phases associated with cartographic scale factors that change in ascending order from the first approach phase to the fourth approach phase.

According to a variant of the system, when an element at risk is located outside the monitoring area, the monitoring information associated with said element at risk is represented by a symbol signalling the presence of said element outside the representation area and it also comprises a means of manually modifying the scale factor making it possible to adapt the scale factor so as to incorporate the element at risk in the representation area.

Thus, the system according to the invention provides landing assistance that automatically takes account of the change of cartographic scale factor on the navigation display screen according to the trend of the current approach phase. The change of scale occurs at each change of approach phase and consequently at conventional steps known to the crew. This makes it possible to overcome the disadvantages of a solution based on a continuous cartographic scale factor determined according, for example, to the distance between the aeroplane and the airport or alternatively the altitude.

Thus, the monitoring system supplies the crew with an adaptive and summary view that makes it possible to ensure a better perception of the situation throughout the final approach and therefore take the best decision in very short times.

Unforeseen situations are then detected more rapidly such as unexpected runway incursions, poor air conditions (slipstream turbulences on the runway), runway characteristics unsuited to the landing (runway too short, too wet, slippery, closed, damaged, etc.). The system according to the invention provides decision-making assistance by displaying to the crew only the information essential to each approach phase, and automatically. The pilots can then decide on the best solution to adopt: go-around, crab landing, etc.

### BRIEF DESCRIPTION OF THE DRAWINGS

The invention will be better understood and other advantages will become apparent from reading the following description given as a nonlimiting example, and by virtue of the appended figures in which:

FIG. 1 represents a diagram of the monitoring system according to the invention.

FIG. 2 represents the successive approach phases during the landing according to a vertical profile.

FIG. 3 represents the successive approach phases during the landing according to a horizontal profile.

FIG. 4 represents a number of display modes of a display device screen of the monitoring system according to the current approach phase.

FIG. 5 represents a number of display modes and in particular the symbols representing an airport area according to the current approach phase.

FIG. 6 represents a number of display modes and in particular the symbols and the representation of monitoring information for an airport area according to the current approach phase. It also represents a function for changing the cartographic scale factor.

### DETAILED DESCRIPTION

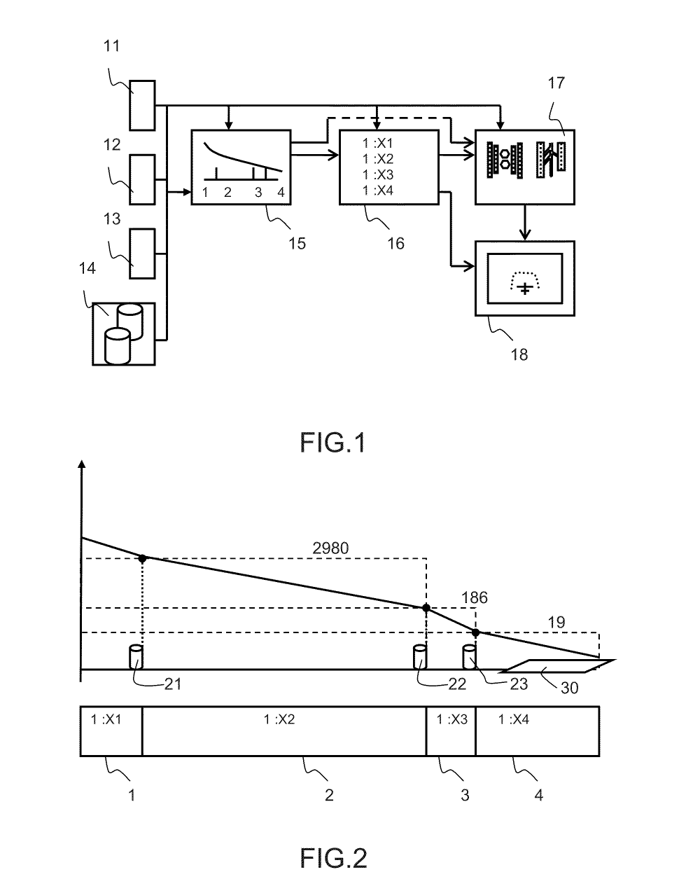

FIG. 1 represents the means that make up the monitoring system according to the invention in order to provide the pilot with decision-making assistance during the landing approach phases. Furthermore, the system comprises a plurality of types of data sources 11, 12, 13 and 14 supplying information useful to the generation of the functions of the invention. Depending on the level of generation of the functions implemented by the invention, the system uses all or some of the available data. These data originate from the following means:
Means 11 of receiving navigation data: The navigation data relate to the location and the situation of the aircraft equipped with the system according to the invention and make it possible notably to determine the approach phases constituting the landing and the current approach phase during the landing. From these data, the system obtains the following information: the position of the aircraft by means of satellite and radio-altimeter location type systems coupled with the data from the navigation management system for example, the position of the runway obtained from the databases of the navigation management system, the information from radio-navigation means well known to those skilled in the art by the acronyms ILS, DME (distance measurement equipment) and VOR (VHF omni-directional range), etc.

More specifically, the radio-navigation means present on the landing area enable the monitoring system to determine automatically during the landing, the current approach phase of the aircraft.

The DME radio-transponders are used to monitor the oblique distance of the aeroplane relative to the beacon which may be situated at the runway threshold for example (DME/P), the VOR system for maintaining the heading of the aircraft on a radial of the ground station, the orientation beacons NDB (non-directional beacons) for reaching a particular point.

The ILS system comprises at least a component, commonly called “localizer” in the profession, which supplies the deviation of the aeroplane relative to the axis of the runway and also a component, commonly called “glide path”, which indicates the deviation of the aeroplane relative to the nominal approach slope (usually between 2.5° and 3.5°).

Markers 21, 22 and 23, symbolized in FIG. 2 (outer marker 21, middle marker 22 and inner marker 23), situated in the axis of the runway at predefined distances (respectively approximately 8 km, 1 km and 100 m) and emitting a vertical beam make it possible to check the height of the aeroplane in the final landing phase.

The design of the invention is not limited to the abovementioned examples, and more generally the present and future navigation data reception means able to receive navigation information in the flight and landing area fall within the scope of the invention.
Means 12 of receiving a plurality of landing area monitoring information: The monitoring data are all the data available relating to the environment of the aeroplane which are of operational interest in the approach phase: other aeroplanes, the position of the elements of the airport, the obstacles, the terrain, the weather conditions, etc.

Such information can be determined with cooperative systems between aeroplanes for the transmission of traffic information, such as, for example, the future ADS-B (automatic depend surveillance-broadcast) or TIS-B (traffic information service-broadcast) communication systems for determining the position of the aeroplanes over time and the aeroplane type. Such information makes it possible to follow the aeroplanes and therefore calculate the congestion of the runway and the presence of slipstream turbulences. Airport information transmission systems, such as D-ATIS (digital automatic terminal information service) provide information on weather conditions, state of the runway, etc.

The design of the invention is not limited to the above-mentioned examples and more generally, the present and future monitoring data reception means able to receive monitoring information concerning the flight and landing area fall within the scope of the invention.
Configuration 14 and aircraft performance 13 databases: The performance data and/or the configuration databases may be used in certain advanced implementations of the invention in order to allow maximum adaptation of the displayed symbols. These represent information relating to the aircraft such as, for example, a characteristic braking distance of the aircraft or also an estimated braking distance during the approach phase.

The monitoring system also comprises display means 18 for representing to the pilot, by various symbols, the landing area and the monitoring information. For this, it is generally a conventional navigation display device with two-dimensional representation, commonly called “navigation display”. In this type of display, the aircraft is represented by a fixed symbol at the bottom of the screen around which the environment moves. Usually, the display mode may be a standard so-called arc mode or a standard so-called rose mode.

The monitoring system also comprises means 15 of determining a plurality of successive approach phases constituting landing procedure and of signalling the current approach phase. Said approach phases are deduced from the navigation data. The functions for determining the approach phases are implemented by a computer. The approach phases determined by the computer correspond to the conventional approach phases well known to a pilot. The navigation information, detailed previously in the description, and the means by which such information is supplied, enable the computer to signal the current approach phase.

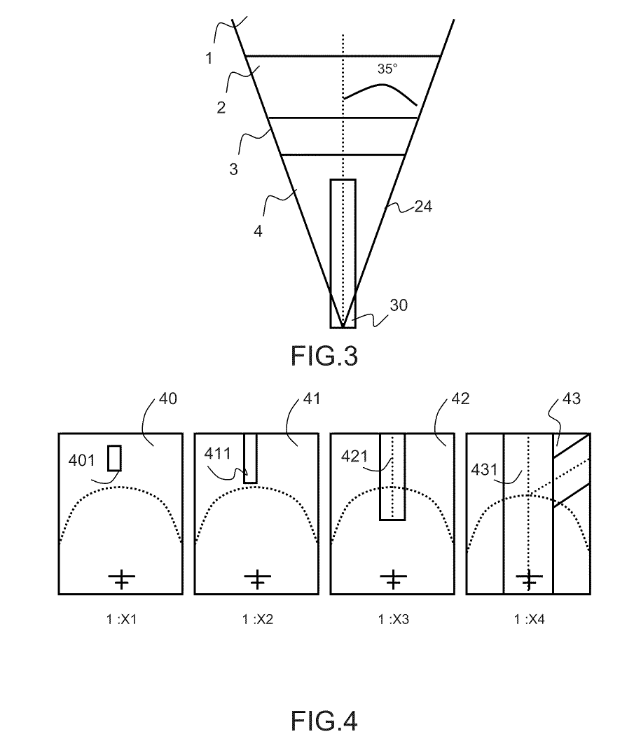

FIGS. 2 and 3 represent the successive approach phases 1, 2, 3 and 4 that constitute the landing according to a vertical profile and a horizontal profile. These approach phases are defined according to the distance from the aeroplane to the runway threshold, its height and its deviation relative to the longitudinal axis of the runway. According to a nonlimiting example of definition of the approach phases, the approach phase 2 begins between 4 and 8 nautical miles from the runway threshold 30 according to the flight plan at a height below 2980 feet plus a margin for error. The approach phase 3 begins at approximately 0.5 nautical miles from the runway threshold 30 or at a maximum height of 186 feet plus a margin for error. The phase 4 begins at 0.05 nautical miles from the runway threshold 30 at a maximum height of 19 feet plus a margin for error. In the horizontal plane, these approach phases 1 to 4 are contained within an isosceles triangular area 24 with an angle between the median and one side of approximately 35 degrees, the apex of which is positioned on the central axis of the runway 30 at the end of the runway and the median of which is longitudinal to the central axis of the runway.

The latter numerical values are indicated by way of example and may be modified according to the type of aeroplane and the airport infrastructure so as to be best adapted to the approach speed of the aeroplane. It will in fact be essential to display the information useful to the current phase for a period that is long enough for the pilots to have time to view the critical data and act accordingly. The number of approach phases that can be determined may also be modified on a case-by-case basis according to operational requirements.

One major functionality of the monitoring system is automatically assigning, according to the current approach phase, a scale factor (1:X1, 1:X2, 1:X3 or 1:X4) for representation of the area displayed on the screen of the navigation display device. For this, the monitoring system also includes means 16 for calculating a plurality of cartographic scale factors of the landing area. FIG. 1 represents, for each approach phase 1-4, a respective cartographic scale factor 1:X1 to 1:X4.

FIG. 4 represents four display modes on a navigation display device screen. The first screen 40 represents a display during the first approach phase; the cartographic scale factor is equal to 1:X1. The aeroplane is represented at the bottom of the screen by an immobile symbol and the selected landing runway is represented by a rectangular object 401. The second screen 41 represents a display during the second approach phase; the cartographic scale factor is equal to 1:X2 greater than 1:X1. The selected landing runway is represented by a rectangular object 411 of larger dimension because the scale factor is greater than 1:X1. The third screen 42 represents a display during the third approach phase; the cartographic scale factor is equal to 1:X3 greater than 1:X2. The selected landing runway is represented by a rectangular object 421 of larger dimension and more detailed form. The fourth screen 43 represents a display during the fourth and final approach phase; the cartographic scale factor is equal to 1:X4 greater than 1:X3. The selected landing runway is represented by a rectangular object 431 of larger dimension and more detailed form and the runway exit lane is also represented.

During the displays 40 and 41, the scale factor is smaller because the aircraft is situated at a distance that is still remote from the runway and the pilot does not require a high level of detail. Furthermore, the pilot needs to see the full distance between his craft and the runway. During the display, the transition between each scale factor is automatic and is produced progressively at the moment of the change from one approach phase to another. This makes it possible to automate and adapt the representation of the approach area according to the progress of the landing, to supply only the information useful to the decisions at the moment of the instantaneous situation. The pilot is thus relieved of the task of selecting information by manipulating display parameters and of analysing useful data among useless data.

In a first basic embodiment, the cartographic scale factors can be defined a priori in system configuration parameters. In a second, more sophisticated embodiment, the cartographic scale factor may be determined according to the respective position of the elements to be monitored on entering an approach phase, such as, for example, the distance between the aeroplane and the runway threshold. In a third variant, the cartographic scale factor may be determined according to the characteristic configuration of the aeroplane stored in a configuration database or according to the current performance parameters of the aeroplane. For example, on the display 43, the distance represented by the length of the screen may be equal to the characteristic braking distance of the aircraft or also the braking distance estimated during the approach phase. Thus, the crew can instantaneously work out whether the aircraft will exit from the runway or will miss its exit.

The monitoring system also comprises means 17 of selecting the monitoring information to be displayed for each approach phase. Based on the monitoring data, the signalled approach phase and the selected cartographic scale factor, the means 17 of selecting monitoring information transmit to the display device 18 the information to be displayed on the screen and the symbols representing said information. Thus, for each approach phase, a set of essential data is then chosen according to the operational needs and is displayed optimally (the cartographic scale factor is adapted to the graphic characteristics of the information to be displayed).

According to another characteristic of the system, the display transitions occur progressively during phases recognized by the pilots (passage over the beacon 21 for example) so as not to create confusion. The adaptation is done according to the scale factor and the current phase. However, it also takes into account the characteristics and performance of the aeroplane (either statically by drawing from a configuration database, or dynamically by using the aeroplane performance data). Furthermore, it adapts its display according to the available monitoring data.

Thus, the display means 18 represent the landing area according to a cartographic scale factor that changes (from 1:X1 to 1:X4) and the selected monitoring information by symbols that also change (401, 411, 421, 431 in FIG. 4), the cartographic scale factor and the symbols changing automatically according to the current approach phase.

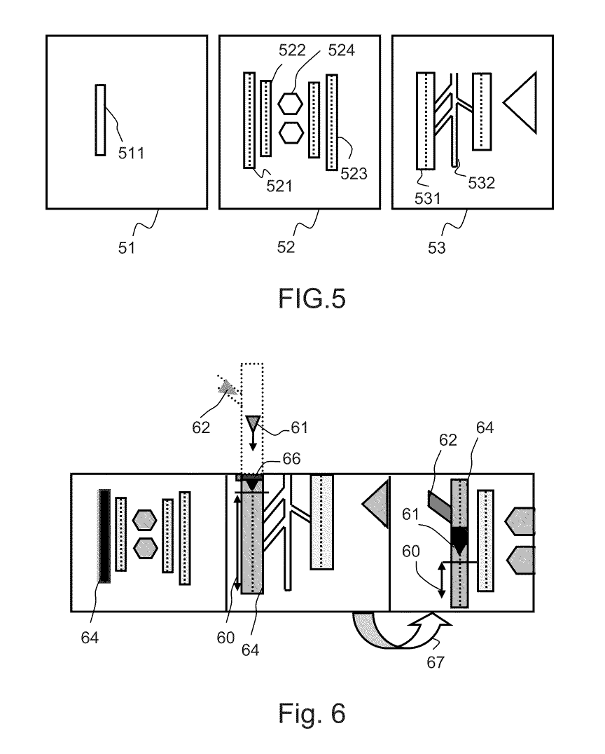

For example, FIG. 5 represents a number of current approach phase display modes for a landing runway symbol. This example illustrates the function of the monitoring system for selecting objects to be displayed according to the current approach phase. In the approach phase 1, the display device represents, in a first display mode 51, the position and the length of the runway by an object 511 in the form of a simple rectangle thus enabling the pilot to locate himself relative to the runway. Then, in the phase 2, the display device also represents, in a second display mode 52, the other runways that may possibly be represented with different symbols 522 and 523 so as not to lose sight of the runway 521 on which the aeroplane will land and the main buildings by the symbol 524 (terminals). This enables the crew to check that it is aligned on the correct runway. Finally, in phases 3 and 4, the display device represents, in a third display mode 53, the exits on the runway 531 by a new symbol 532 in order to enable them to anticipate their braking and the start of taxiing.

Furthermore, the display means represent a monitoring information item by a symbol whose form and graphic representation characteristics change according to the current approach phase. In FIG. 5, the objects 511, 521 and 531 represent one and the same information item, but the level of detail displayed changes according to the current approach phase.

Another example of information that can be displayed may be cited, such as slipstream turbulences. This symbol is deduced from more basic monitoring information. Based on the knowledge of the position of the runway and of that of the other aeroplanes, it is possible to know whether an aeroplane has just taken off. Furthermore, if the aeroplane information comes from cooperative sources (ADS-B or TIS-B for example), the type of aeroplane is known. Based on aeroplane characteristics contained in the database, it is possible to know the scale of the slipstream turbulence that the system can compare with the sensitivity of the carrier to such turbulence. If the system also has an indication concerning the wind on the ground, it can estimate the dissipation of the slipstream turbulence. Thus, the information selection means 17 can therefore choose to display or not display a turbulence symbol and/or to adapt it to the danger by a colour code for example.

In more sophisticated variants, other symbols may be displayed, such as a vortex accompanied or not by a countdown specifying the time remaining before the turbulences disappear. In a simpler variant, these turbulences may be represented as a cluttering of the runway. For example, a red area may be drawn at the end of the runway and reduce in intensity, or in level of transparency, over time.

Another example of information that can be displayed may be cited, such as the cluttering of the runway. This representation is essential information during an approach phase to enable pilots to best appreciate the danger coming from ground traffic.

To represent this information, various graphic representation characteristics can be used and which are chosen automatically by the monitoring system. It is possible, for example, to use a colour code, specific symbols (red cross, three-colour lamp, to show that three states are possible, etc.), textual indications, trend information to anticipate changes of state (arrows, oriented shapes such as triangles, etc.).

Furthermore, the level of precision of this representation depends on the approach phase. FIG. 6 represents a few examples. During the approach phase 1, the state of occupancy of the runway 64 may not be indicated because, during this phase, this datum is not priority information given that this state will probably change during the final approach. In the approach phase 2, the cartographic scale factor level does not make it possible to correctly view the detail of the runways 64; it is sufficient to indicate whether the runway 64 is occupied (coloured red for example), free (coloured green for example) or on the point of being occupied (orange strip to the right or left of the runway depending on the position of the conflicting mobile, for example).

The “on the point of being occupied” state may be defined according to the position of the mobiles 61 and 62 relative to the runway 64, their direction, their speed and possibly their ATC instruction if it is known. Only the mobiles likely to enter onto the runway are taken into account in the representation of the information on the screen (up to phase 3).

In the phase 3, the dangerous areas of the runway and taxiways can be represented more precisely. Although the display shows only the portion of the runway necessary for braking according to the aeroplane characteristics 60 (braking distance) and its performance, the system may signal occupancy of the runway beyond this area or the risks of runway incursions by means of an object 66.

According to a variant of the invention, a manual modification means may be put in place to rapidly view the area or the hazardous areas. For example, during the continual selection of a knob, the display progressively reduces the scale factor, this action being represented by the arrow 67, to display all of the runway 64. Then, by deselecting the knob, the display reverts to the initial scale factor.

In a preferred embodiment of the monitoring system, the navigation display device supplies the following information during the approach phases:

During phase 1, the terrain map is displayed together with any radio navigation information (beacons, etc.), weather information, terrain obstacles and flying traffic, the flight plan including a simplified symbol of the landing runway and, if appropriate, information concerning runway occupancy.

During the phase 2, symbols give a more precise representation of the landing runways and of certain airport buildings. This enables the pilots to see whether they are aligned on the correct runway and to begin to appreciate the airport area. Particular symbols are defined to represent the cluttering of the runway globally, possible slipstream turbulences, the state of the runway (runway closed, slippery, wet, damaged, etc.), known signage panels deriving from road traffic (direction prohibited, slippery road, hump, etc.) or equivalent may be employed to give a more meaningful representation of these hazards, the weather conditions (wind force, wind direction, etc.), an arrow indicating the direction of the wind and its force may be represented together with a set of meaningful weather indications. To optimize the display by showing at the same time the aeroplane, the entire runway and the information useful to the monitoring, the system will switch automatically to the arc mode and will select the most suitable range.

During the phase 3, a smaller scale factor is activated to view at least the area of the runway that is useful for braking. The runway exits corresponding to the runway on which the aeroplane will land appear. This runway is either the one specified in the navigation management system of the aircraft or the one with which the aeroplane is aligned (comparison of aeroplane heading with airport data obtained from the databases). The runway occupancy symbols are specified and the runway state symbol is retained. The braking plane may also be represented, together with surrounding traffic.

Finally, in phase 4, the monitoring system presents a standard so-called OANS (onboard airport navigation system) display mode dedicated to the taxiing phase.

During these phases, if the system detects a go-around, the phase 1 display parameters are reactivated.

The invention is a monitoring system dedicated to the aircraft approach phase. The functions carried out by the system are implemented in one or more onboard computers, such as, for example, the navigation management system computer.

1. A monitoring system dedicated to approach phases, including a landing phase, of an aircraft, comprising:
means of receiving navigation data,
means of receiving a plurality of landing area monitoring information, and
display means representing, by various symbols, the landing area and the monitoring information,
further comprising
means of determining a plurality of successive approach phases and of signalling the current approach phase, the approach phases being deduced from the navigation data,
means of calculating a plurality of cartographic scale factors of the landing area, one factor being dedicated to one approach phase, and
means of selecting monitoring information to be displayed for each approach phase, the selected information depending on the current approach phase,
the abovementioned means being arranged together so that, during the approach phases, the display means represent the landing area according to a changing cartographic scale factor and the selected monitoring information by symbols that also change, the cartographic scale factor and the symbols changing automatically according to the current approach phase, a first cartographic scale factor being modified to a second factor according to a progressive transition produced during the transition from one approach phase to the next approach phase.

2. The system according to claim 1, wherein the means of calculating the cartographic scale factors are configured to define a plurality of factors before the approach phases.

3. The system according to claim 1, wherein the means of calculating the cartographic scale factors are configured to define a plurality of factors as the approach phases progress according to the monitoring information, notably location and dimension information concerning elements to be monitored.

4. The system according to claim 1, further comprising aircraft configuration and performance data sources, wherein the means of calculating the cartographic scale factors are configured to define a plurality of factors as the approach phases progress according to said data, notably braking distance data.

5. The system according to claim 1, wherein the display means represent a monitoring information item by a symbol, the shape and the graphic representation characteristics of which change according to the current approach phase.

6. The system according to claim 5, wherein the landing comprises at least two successive approach phases associated with cartographic scale factors that change in ascending order from the first approach phase to the last approach phase.

7. The system according to claim 1, wherein, when an element at risk is located outside the monitoring area, the monitoring information associated with said element at risk is represented by a symbol signalling the presence of said element outside the representation area and it also comprises a means of manually modifying the scale factor making it possible to adapt the scale factor so as to incorporate the element at risk in the representation area.
